(19) United States
(12) Patent Application Publication
(10) Pub. No.: US 2008/0253262 A1
(43) Pub. Date: Oct. 16, 2008

(54) Multi Layer Variable Refractive Index Unit

(75) Inventors: Ole Klembt Andersen, Voorburg (NL); Marcello Leonardo Mario Balistreri, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,991

(22) PCT Filed: Mar. 8, 2005
(86) PCT No.: PCT/IB05/50840

§ 371 Date: Sep. 18, 2006

(30) Foreign Application Priority Data
Mar. 22, 2004 (EP) 04101177.6

(51) Int. Cl. G11B 7/135

(52) U.S. Cl. 369/112.02

(57) ABSTRACT

A variable refractive index unit (140) includes an optical axis and a first layer (144a, 146a, 146a′ of controllably variable refractive index extending in a first predetermined configuration in a first plane transverse the optical axis. A second, different layer (144b, 146b, 146b′ of controllably variable refractive index extends in a second predetermined configuration in a second, different plane transverse the optical axis. The second layer (144b, 146b, 146b′) overlaps the first layer (144a, 146a, 146a′).

### FIELD OF THE INVENTION

The present invention relates to a variable refractive index unit, to optical devices including such a variable refractive index unit, and to methods of manufacturing such a unit.

### BACKGROUND OF THE INVENTION

A variable refractive index unit is a device in which the refractive index of at least a portion of the device can be controllably altered. Such units can be used, for instance, to control the phase of light being transmitted through the unit. The term light is understood to include both visible electromagnetic radiation and other wavelengths of electromagnetic radiation.

Information recording media for optically recording and reproducing information (i.e. optical record carriers) come in a variety of formats. For instance, various types of optical disc exist, such as CDs (Compact Discs) and DVDs (Digital Video Discs or Digital Versatile Discs). A recording medium having a plurality of recording layers on the same recording surface (such as a two-layer-per-side DVD) is also being developed. Further, high-density optical-storage devices are being developed such as BD (Blu-Ray).

It can be necessary to correct for wavefront errors in the optical signal used to read from and/or write to such optical record carriers.

For instance, high-density optical record carriers typically require an objective lens having a high NA (Numerical Aperture), thus increasing the wavefront aberration of the optical beam.

Such aberrations can lead to a consequent loss in device performance e.g. in accuracy in reading and/or writing information from/to the optical record carrier. Consequently, in high-density optical-storage devices it can be desirable to dynamically correct all wavefront errors as the disc is scanned. For instance, the effect of aberration produced by errors or variations in the thickness of a disc cover layer can become significant.

U.S. Application No. 10/050,604 (Published as publication No. U.S. 2002/0105890 A1) describes an aberration correcting apparatus suitable for correcting spherical aberration. FIGS. 1 and 2 are respectively plan and cross-sectional views of the same type of aberration correcting element.

FIG. 1 illustrates a plan view of the element 40 extending generally in the X-Y plane; an expanded view 40′ of a portion of the element 40 is also shown. The element 40 is circular, and generally circularly symmetric.

FIG. 2 shows a radial cross-sectional view of the element 40 extending generally in the direction Z, with ρ being the radial distance i.e. ρ=0 is the centre of the element, and ρ=500 is the outer periphery of the element.

The element 40 can be seen to include a planar layer of liquid crystal 44 of uniform thickness extending generally across the whole area of the element 40. The particular element illustrated is functionally divided into eleven different annular segments (42a, 42b, 42c, . . . 42k). Each segment comprises a pair of transparent electrodes arranged either side of the liquid crystal layer 44. For instance, the electrodes 46a, 46′a located in the outer segment 42a sandwich the liquid crystal 44, these electrodes being of width A. Each electrode is separated from the neighbouring electrode in the same layer by a gap 43, to prevent electrical contact between adjacent electrodes e.g. electrode 46′a is separated from electrode 46′b by gap 43. By varying the voltage across each pair of electrodes, the orientation of the nematic liquid crystal between the electrodes can be altered, so as to impart the desired phase shift to an incident optical signal.

The number of annular segments, and the width of each annular segment, is determined by the phase functions that the element 40 is required to provide. For instance, the element 40 shown in FIGS. 1 and 2 is suitable for providing spherical aberration compensation. Consequently, a number of the annular segments towards the periphery of the element must have a relatively thin width, so as to provide the required relatively large change in phase shift over a short radial distance. Particularly for applications involving a high numerical aperture objective lens, the desired width of the electrodes located at the outer rim of the element becomes so small as to make manufacturing difficult. Further, the gap 43 required to separate adjacent electrodes is undesirable, as it can lead to anomalies in the orientation of the liquid crystal layer 44, and therefore anomalies in the phase function provided by the element.

### SUMMARY OF INVENTION

It is an object of embodiments of the present invention to address one or more of the problems of the prior art, whether referred to herein or otherwise. It is an aim of particular embodiments of the present invention to provide a variable refractive index unit suitable for providing relatively steep phase-profiles to incident light beams, whilst still being relatively easy to manufacture.

According to a first aspect of the present invention there is provided a variable refractive index unit comprising an optical axis, a first layer of controllably variable refractive index extending in a first predetermined configuration in a first plane transverse the optical axis, and a second, different layer of controllably variable refractive index extending in a second predetermined configuration in a second, different plane transverse the optical axis. The second layer overlaps the first layer.

The term overlap indicates that the second layer either partly covers the first layer, or covers the first layer and extends beyond the first layer. By overlapping such layers, variable refractive index units can be produced that provide a steep phase-profile, but are still easy to manufacture, by utilising only a thin portion of one layer extending beyond the other layer. Further, as the unit uses overlapping layers, different phase profiles can be produced without anomalies appearing within the phase profile due to the presence of gaps between adjacent segments.

Preferable the unit further comprises at least a third layer of controllably variable refractive index extending in a third predetermined configuration in a third plane transverse the optical axis, the third layer overlapping both the first layer and the second layer.

Preferably, each layer of controllably variable refractive index comprises a layer of material having variable refractive index, each of said layers of material being of uniform thickness.

More preferably, each of said layers comprises a liquid crystal layer sandwiched between two transparent electrodes for control of the refractive index of the liquid crystal layer. Preferably, the unit further comprises a control unit for controlling the voltage applied to each electrode.

Preferably, said electrodes only sandwich a portion of said liquid crystal layer.

Preferably, each of said layers is parallel.

Preferably, each of said layers is annular, each annulus being of a different size.

More preferably, each annulus is located around a common axis.

Preferably, the unit is arranged to correct for aberrations in an optical wavefront by controlling the refractive index of said layers to provide a predetermined phase-profile to an incident optical signal.

According to a second aspect of the present invention there is provided an optical device comprising a unit as described above.

Preferably, the optical device is an optical scanning device for scanning an information layer of an optical record carrier, the device further comprising a radiation source for generating a radiation beam and an objective system for converging the radiation beam on the information layer.

According to a third aspect of the present invention there is provided a method of operating an optical device, the optical device comprising a unit as described above. The method comprises controlling the refractive index of at least one of said layers of controllably variable refractive index so as to provide a predetermined phase modulation to incident optical signals.

According to a fourth aspect of the present invention there is provided a method of manufacturing an optical device. The method comprises providing a first layer of controllably variable refractive index extending in a first predetermined configuration in a first plane transverse an optical axis. The method further comprises providing a second, different layer of controllably variable refractive index extending in a second predetermined configuration in a second, different plane transverse the optical axis, such that the second layer overlaps the first layer.

### BRIEF DESCRIPTION OF DRAWINGS

For a better understanding of the invention, and to show how embodiments of the same may be carried into effect, reference will now be made, by way of example, to the accompanying diagrammatic drawings in which:

FIG. 1 shows a plan view, including a close-up view of one section, of a known optical element;

FIG. 2 shows a radial cross-section of the element of FIG. 1;

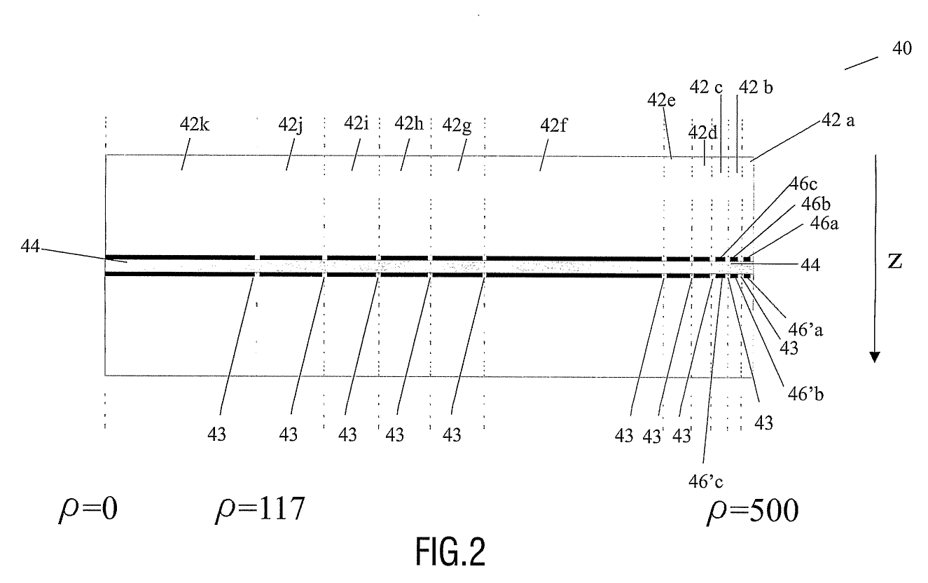

FIG. 3 shows a radial cross-section of a variable refractive index unit in accordance with a first embodiment of the present invention;

FIG. 4 shows a plan view of the unit of FIG. 3;

FIG. 5 shows a phase function that can be provided by the unit of FIG. 3, to compensate for spherical aberrations; and

FIG. 6 shows a schematic diagram of an optical scanning device in accordance with an embodiment of the present invention.

### DESCRIPTION OF PREFERRED EMBODIMENTS

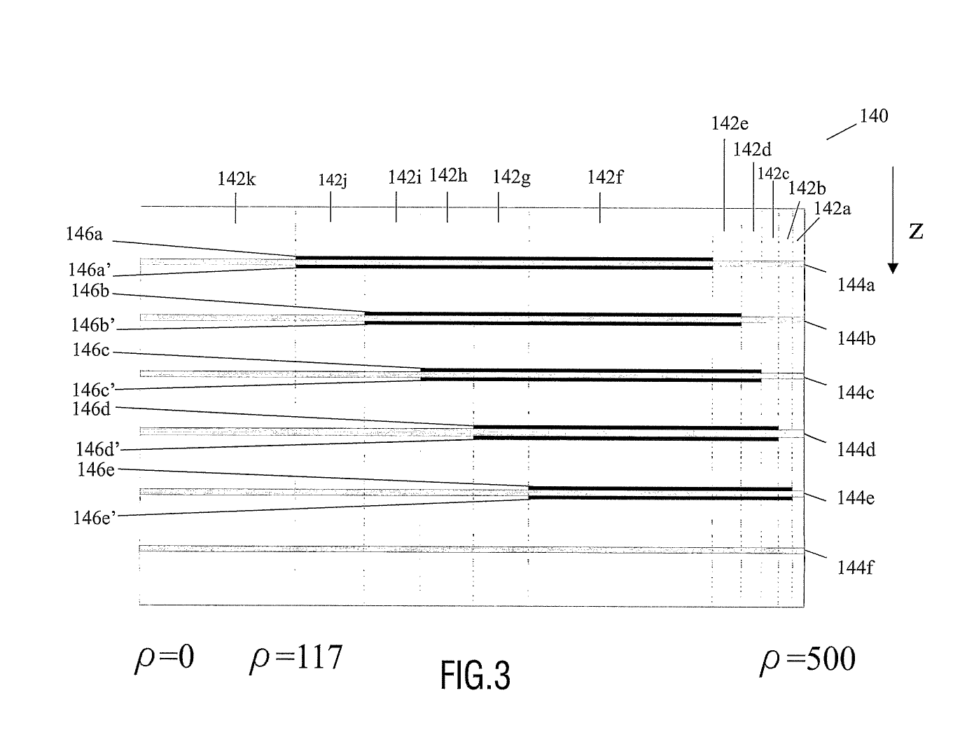

FIG. 3 shows a cross-sectional view of a variable refractive index unit 140. The cross-sectional view is taken along the radius of the unit, with ρ indicating the distance along the radius from the centre. The value of ρ is in microns.

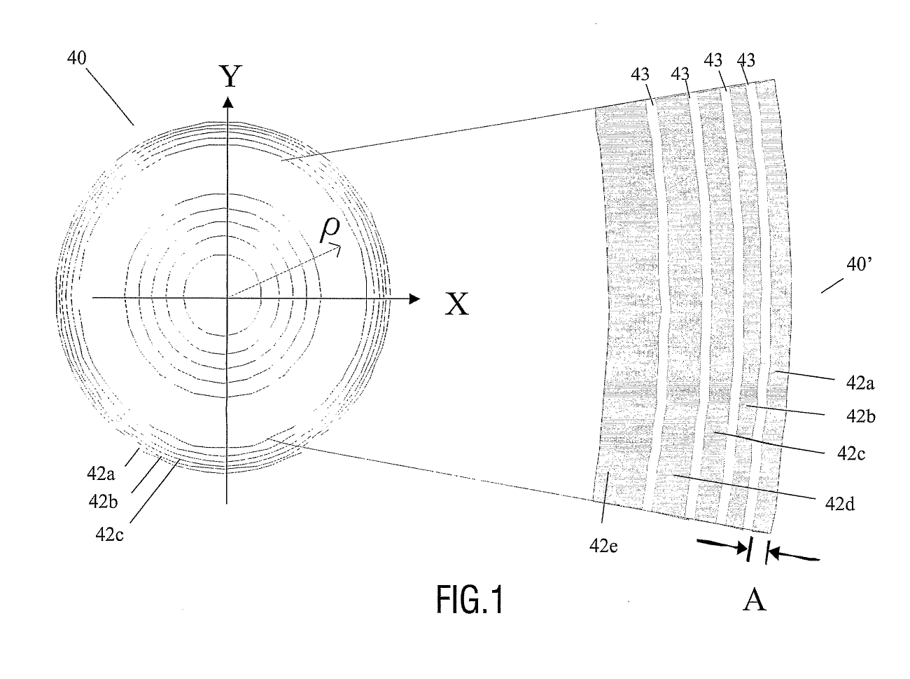

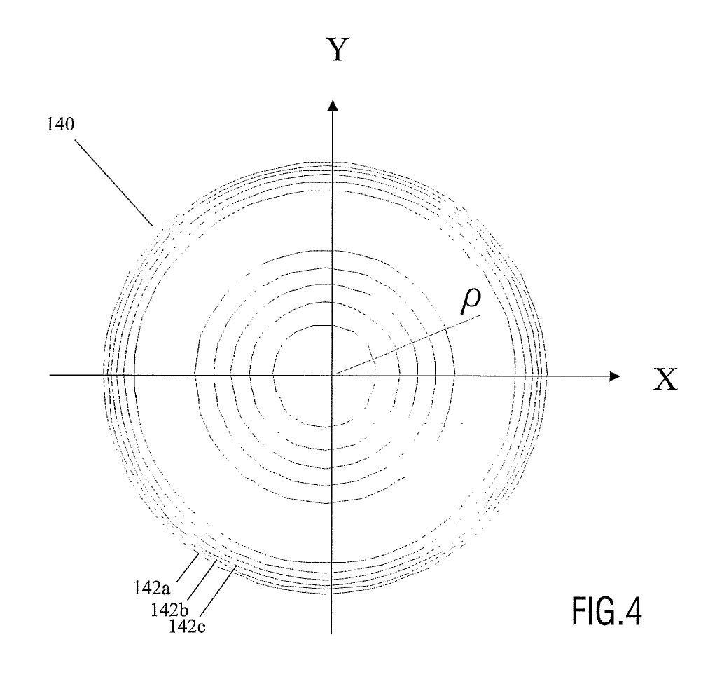

FIG. 4 shows a plan view of the unit 140. The plan view of the unit 140 appears generally similar to the prior art element 40 shown in FIG. 1. The unit 140 is arranged to provide a phase-function suitable for spherical aberration correction. Consequently, the unit 140 is circularly symmetric. Functionally, it is effectively divided up into a plurality of coaxial annular segments 142a-142k. Each segment is capable of providing a different phase shift to an incident radiation beam. An important distinction of this unit 140 over the prior art shown in FIG. 1 is that the unit 140 does not have gaps 43 between adjacent segments.

As can be seen from FIG. 3, the unit 140 is formed of a plurality of layers of liquid crystal 144a-144f. In this particular embodiment, the unit 140 is formed of six separate layers of liquid crystal. To simplify the manufacturing process, each layer extends substantially across the full area of the unit 140, with each layer 140a-140f being of uniform thickness. Further, to simplify the design criteria, each layer is of substantially equal thickness, i.e. the layer 144a is the same thickness as layer 144b. The layers 140a-140f are parallel, with each layer extending in a plane substantially perpendicular to the optical axis of the unit 140. The optical axis extends parallel to the Z axis through the radial centre of the unit (i.e. through ρ=0).

Of the six layers of liquid crystal 144a-144f, all but one (144f) of the layers is partially enclosed by a respective pair of transparent electrodes 146a, 146a′, . . . 146e, 146e′.

By applying a voltage across a pair of electrodes, the orientation of the liquid crystal sandwiched between the electrodes can be varied. Consequently, by controlling the voltage applied across each pair of electrodes, the refractive index of the liquid crystal sandwiched between the electrodes can be controllably varied. In this embodiment the electrodes are generally planar, and each electrode extends in a plane substantially parallel to the relevant liquid crystal layer i.e. electrodes 146a, 146a′ extend parallel to liquid crystal layer 144a.

In this embodiment, each electrode is annular, with each electrode in a given pair being of uniform configuration, i.e. shape and size. As the electrodes are used to control the refractive index of the liquid crystal, each pair of electrodes together with the liquid crystal sandwiched between the electrodes functionally acts so as to effectively provide a layer of controllably refractive index extending in a predetermined configuration in a plane transverse the optical axis. In this particular embodiment, the plane extends perpendicular to the optical axis, although it will be appreciated that the term transverse also covers instances in which the plane extends at any angle that is not parallel to the optical axis.

The pairs of electrode are arranged such that each effective functional layer of controllably variable refractive index overlaps another layer of controllably variable refractive index. For instance, the functional layer provided by the electrode 146e, 146e′ enclosing the liquid crystal layer 144e, extends into segment 142b, and hence beyond the end of the functional layer provided by electrodes 146d, 146d′ enclosing liquid crystal layer 144d (which only extends up to and including segment 142c) at the periphery. As the area of overlap (i.e. segment 142b) is of relatively thin width (i.e. 10 microns), this allows the unit 140 to provide a steep phase shift profile whilst still using relatively wide electrodes.

The variable refractive index unit 140 shown in FIGS. 3 and 4 is arranged to provide a phase-function suitable for compensating for the wave front error arising from the cover layer of a disc being 90 microns instead of the nominal value of 100 microns i.e. the other layer being 10 microns thinner than the specification. It is assumed that the radiation beam used to scan the optical disc is of wavelength λ₀₌0.4 microns. Each step (change in phase) within the phase function is of value 0.37157 radians. Table 1 indicates how the phase function correlates with each functional segment (142a-142k). The inner radius of each radial segment is indicated by the value of ρ_{INNER}, with the outer radius being indicated by ρ_{OUTER}, each segment being of width Δρ, with the phase shift in radians imparted by each segment also being indicated.

TABLE 1

| Segment | ρ_{INNER} (μm) | ρ_{OUTER} (μm) | Δρ (μm) | Phase (Radians) |
|---|---|---|---|---|
| 142k | 0 | 117 | 117 | −0.18578 |
| 142j | 117 | 169 | 52 | −0.55735 |
| 142i | 169 | 211 | 42 | −0.92892 |
| 142h | 211 | 251 | 40 | −1.30049 |
| 142g | 251 | 293 | 42 | −1.67205 |
| 142f | 293 | 432 | 139 | −2.04362 |
| 142e | 432 | 453 | 21 | −1.67205 |
| 142d | 453 | 469 | 16 | −1.30049 |
| 142c | 469 | 481 | 12 | −0.92892 |
| 142b | 481 | 491 | 10 | −0.55735 |
| 142a | 491 | 500 | 9 | −0.18578 |

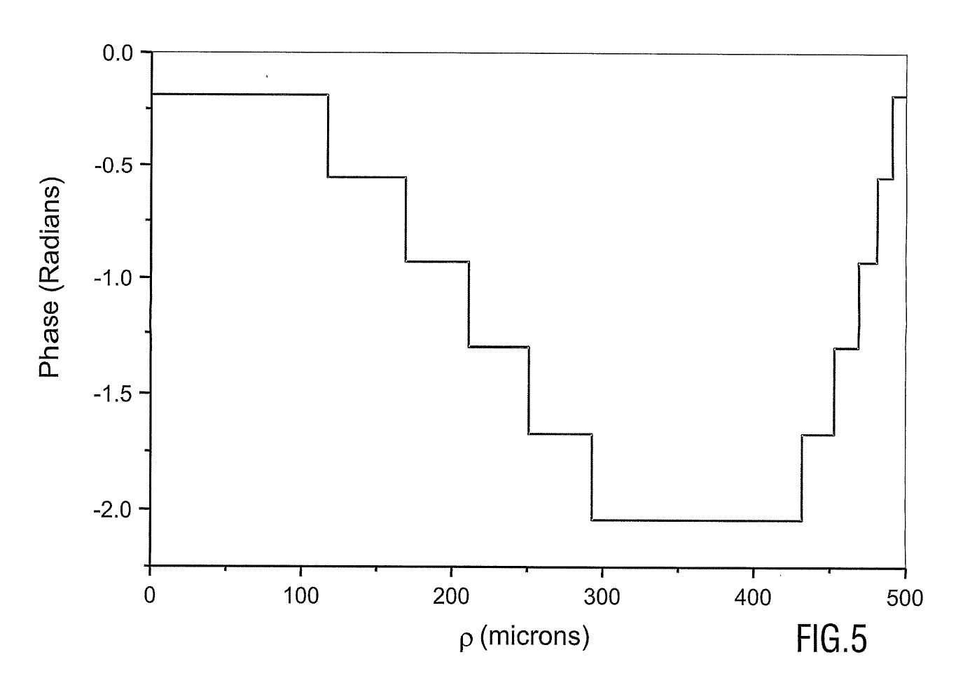

FIG. 5 illustrates the variation of phase shift in radians with radial distance, in accordance with Table 1.

As can be seen from FIG. 3, in this embodiment the annular functional layers of controllably variable refractive index are arranged such that each successive functional layer is of greater inner radius and of greater outer radius than the preceding functional layer, with each functional layer extending across a predetermined number (in this instance, five) of segments. The total phase shift provided by a segment of the unit 140 is the summation of the phase shifts provided by each of the functional layers aligned within that segment. For instance, in segment 142j, only the functional layer provided by electrodes 146a, 146a′ covering a portion of the liquid crystal layer 144a appears in that segment, and hence is responsible for the phase change of that segment. In contrast, each of the five functional layers falls within segment 142f, and so the phase shift experienced by a radiation beam being transmitted through segment 142f will be the accumulative phase shift provided by these layers.

Assuming the liquid crystal not confined between electrodes has a refractive index n, then the refractive index of the liquid crystal located between the electrodes can be indicated as being of n-|Δn|, where Δn is the absolute refractive index difference caused by voltage being applied between the electrodes. The absolute value of the difference in refractive index Δn between each neighbouring segment is determined by the relationship:

$$2 π \frac{{d}_{LC} \vert Δ n \vert}{{λ}_{0}} = 0.37157$$

where d_{LC} is the thickness of each liquid crystal layer and 0.37157 is the value of the step (change in phase shift) between each segment. For instance, if d_{LC} is assumed to be approximately 1 micron, and the radiation beam is assumed to be of wavelength λ₀₌0.4 microns, then for the phase step of 0.37157, this gives an absolute refractive index difference of Δn of approximately 0.0237.

It can be readily seen from FIG. 3 that the electrodes used in the multi-layer unit 140 of the present invention are much wider than the electrodes used in the single-layer of version of the prior art. For instance, it can be determined from Table 1 that the widths of the electrodes in the embodiment illustrated in FIG. 3 vary between 198 microns and 315 microns (as compared to electrodes in the prior art design having to be a similar size to the segments, and hence varying in width from 139 microns down to, a difficult to manufacture size of, 9 microns).

The functional layers are separated from each other by a transparent material e.g. by layers of glass. The typical thickness of each glass layer between each functional layer is envisaged to be approximately 100 microns in the above embodiment. The electrodes can be manufactured from any transparent material e.g. PEDOT (Poly (3,4-ethylenedioxythiophene)). Preferably, in order to maximise the proportion of the radiation beam transmitted through the unit, the electrodes are relatively thin e.g. of thickness less than 50 nanometres, and more preferably of thickness less than 15 nanometres.

It will be appreciated that the above embodiment is provided by way of example only, and that various alternatives will be apparent the skilled person. For instance, in the above embodiment, each functional layer of controllably variable refractive index is provided by a pair of electrodes sandwiching a layer of liquid crystal. Each such functional layer could of course be provided by any material in which the refractive index can be controllably varied, in conjunction with the control means to effect that change. Further, a specific configuration of the unit has been described suitable for correcting spherical aberrations. It would be appreciated that other configurations will be suitable for providing other functions e.g. for correcting for coma in an optical wavefront. Further, other configurations could indeed be utilised to correct spherical aberration other than the particular configuration illustrated in FIGS. 3 and 4.

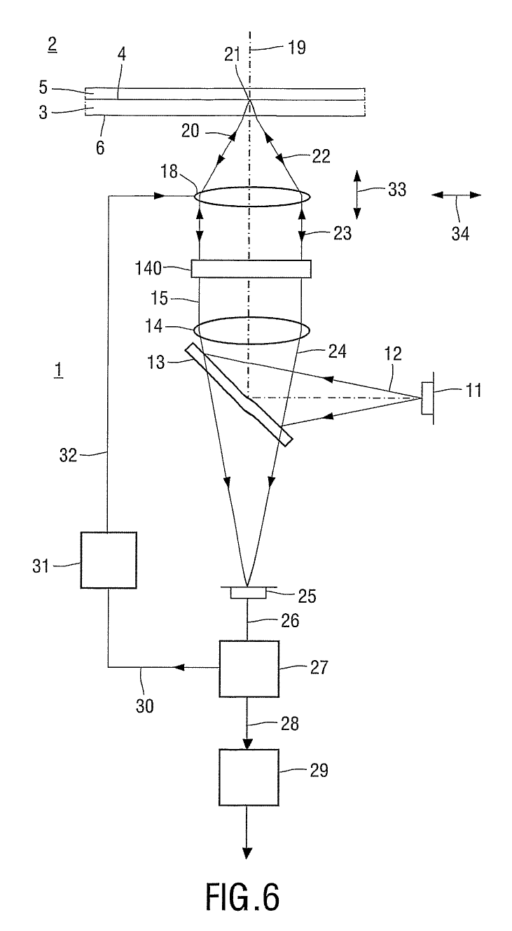

Variable refractive index units in accordance with embodiments of the present invention can be used in a variety of applications and devices. FIG. 6 shows a device 1 for scanning an optical record carrier 2, including an objective lens system 18. The record carrier comprises a transparent layer 3, on one side of which an information layer 4 is arranged. The side of the information layer facing away from the transparent layer is protected from environmental influences by a protection layer 5. The side of the transparent layer facing the device is called the entrance face 6. The transparent layer 3 acts as a substrate for the record carrier by providing mechanical support for the information layer.

Alternatively, the transparent layer may have the sole function of protecting the information layer, while the mechanical support is provided by a layer on the other side of the information layer, for instance by the protection layer 5 or by a further information layer and a transparent layer connected to the information layer 4.

Information may be stored in the information layer 4 of the record carrier in the form of optically detectable marks arranged in substantially parallel, concentric or spiral tracks, not indicated in FIG. 6. The marks may be in any optically readable form, e.g. in the form of pits, or areas with a reflection coefficient or a direction of magnetisation different from their surroundings, or a combination of these forms.

The scanning device 1 comprises a radiation source 11 that can emit a radiation beam 12. The radiation source may be a semiconductor laser. A beam splitter 13 reflects the diverging radiation beam 12 towards a collimator lens 14, which converts the diverging beam 12 into a collimated beam 15. The collimated beam 15 is incident on an objective system 18.

The objective system 18 may comprise one or more lenses and/or a grating. The objective system 18 has an optical axis 19. The objective system 18 changes the beam 17 to a converging beam 20, incident on the entrance face 6 of the record carrier 2. The objective system has a spherical aberration correction adapted for passage of the radiation beam through the thickness of the transparent layer 3. The converging beam 20 forms a spot 21 on the information layer 4. Radiation reflected by the information layer 4 forms a diverging beam 22, transformed into a substantially collimated beam 23 by the objective system 18 and subsequently into a converging beam 24 by the collimator lens 14. The beam splitter 13 separates the forward and reflected beams by transmitting at least part of the converging beam 24 towards a detection system 25. The detection system captures the radiation and converts it into electrical output signals 26. A signal processor 27 converts these output signals to various other signals.

One of the signals is an information signal 28, the value of which represents information read from the information layer 4. The information signal is processed by an information processing unit for error correction 29. Other signals from the signal processor 27 are the focus error signal and radial error signal 30. The focus error signal represents the axial difference in height between the spot 21 and the information layer 4. The radial error signal represents the distance in the plane of the information layer 4 between the spot 21 and the centre of a track in the information layer to be followed by the spot. The focus error signal and the radial error signal 30 are fed into a servo circuit 31, which converts these signals to servo control signals 32 for controlling a focus actuator and a radial actuator respectively. The actuators are not shown in FIG. 6. The focus actuator controls the position of the objective system 18 in the focus direction 33, thereby controlling the actual position of the spot 21 such that it coincides substantially with the plane of the information layer 4. The radial actuator controls the position of the objective lens 18 in a radial direction 34, thereby controlling the radial position of the spot 21 such that it coincides substantially with the central line of track to be followed in the information layer 4. The tracks in FIG. 6 run in a direction perpendicular to the plane of FIG. 6.

The device of FIG. 6 in this particular embodiment is adapted to scan also a second type of record carrier having a thicker transparent layer than the record carrier 2. The device may use the radiation beam 12 or a radiation beam having a different wavelength for scanning the record carrier of the second type. The NA of this radiation beam may be adapted to the type of record carrier. The spherical aberration compensation of the objective system must be adapted accordingly.

For instance, in dual layer DVR (Digital Video Recording) discs, the two information layers are at depths of 0.1 mm and 0.08 mm; they are thus separated by typically 0.02 mm. When refocusing from one layer to another, due to the difference in information layer depth, some 200mλ of unwanted spherical aberration arises, which needs to be compensated. This can be achieved by introducing a predetermined amount of spherical aberration into the objective system 18, such that the spherical aberrations cancel out.

In one embodiment of this invention, spherical aberration is introduced into the objective system 18 by altering the phase of the beam 15 incident upon the objective system 18, by using a variable refractive index unit 140 in accordance with an embodiment of the present invention. Such a variable refractive index unit 140 can be incorporated as an extra device within the optical path of the beam 15 or can form part of the lens 14. By varying the refractive indices of the layers within the unit, the phase distribution across the beam 15 can be varied, so as to introduce the desired spherical aberration.

The desired spherical aberration is induced by applying an appropriate control signal (or control signals) to the variable refractive index unit 140. For instance, if the variable refractive index 140 utilizes layers of liquid crystal sandwiched between respective electrodes, then appropriate voltage signals will be provided from a voltage source to vary the refractive indices within each layer as desired to provide the desired total spherical aberration.

By providing variable refractive index units utilizing overlapping layers of controllably variable refractive index, it is possible to provide units in which a refractive index change occurs over a small area, without requiring individual corresponding small area layers having variable refractive indices.

1. A variable refractive index unit (140) comprising:
an optical axis;
a first layer (144a, 146a, 146a′) of controllably variable refractive index extending in a first predetermined configuration in a first plane transverse the optical axis; and
a second, different layer (144b, 146b, 146b′) of controllably variable refractive index extending in a second predetermined configuration in a second, different plane transverse the optical axis;
wherein the second layer (144b, 146b, 146b′) overlaps the first layer (144a, 146a, 146a′).

2. A unit as claimed in claim 1, further comprising at least a third layer (144c, 146c, 146c′) of controllably variable refractive index extending in a third predetermined configuration in a third plane transverse the optical axis, the third layer (144c, 146c, 146c′) overlapping both the first layer (144a, 146a, 146a′) and the second layer (144b, 146b, 146b′).

3. A unit as claimed in claim 1, wherein each layer (144a-144e, 146a-146e, 146a′-146e′) of controllably variable refractive index comprises a layer (144a-144e) of material having variable refractive index, each of said layers (144a-144e) of material being of uniform thickness.

4. A unit as claimed in claim 1, wherein each of said layers (144a-144e, 146a-146e, 146a′-146e′) of controllably variable refractive index comprises a liquid crystal layer (144a-144e) sandwiched between two transparent electrodes (146a-146e, 146a′-146e′) for control of the refractive index of the liquid crystal layer (144a-144e),
the unit further comprising a control unit for controlling the voltage applied to each electrode.

5. A unit as claimed in claim 4, wherein said electrodes (146a-146e, 146a′-146e′) only sandwich a portion of said liquid crystal layer (144a-144e).

6. A unit as claimed in claim 1, wherein each of said layers (144a-144e, 146a-146e, 146a′-146e′) is parallel.

7. A unit as claimed in claim 1, wherein each of said layers (144a-144e, 146a-146e, 146a′-146e′) is annular, each annulus being of a different size.

8. A unit as claimed in claim 7, wherein each annulus is located around a common axis.

9. A unit as claimed in claim 1, wherein the unit is arranged to correct for aberrations in an optical wavefront by controlling the refractive index of said layers (144a-144e, 146a-146e, 146a′-146e′) to provide a predetermined phase-profile to an incident optical signal.

10. An optical device (1) comprising a unit (140) as claimed in claim 1.

11. An optical device (1) as claimed in claim 10, wherein the optical device (1) is an optical scanning device for scanning an information layer (4) of an optical record carrier (2), the device (1) further comprising a radiation source (11) for generating a radiation beam (12) and an objective system (18) for converging the radiation beam (12) on the information layer (4).

12. A method of operating an optical device (1), the optical device (1) comprising a unit (140) as claimed in claim 1, the method comprising:
controlling the refractive index of at least one of said layers (144a-144e, 146a-146e, 146a′-146e′) of controllably variable refractive index so as to provide a predetermined phase modulation to incident optical signals.

13. A method of manufacturing an optical device (1), the method comprising:
providing a first layer (144a, 146a, 146a′) of controllably variable refractive index extending in a first predetermined configuration in a first plane transverse an optical axis; and
providing a second, different layer (144b, 146b, 146b′) of controllably variable refractive index extending in a second predetermined configuration in a second, different plane transverse the optical axis, such that the second layer overlaps the first layer.
